(19) United States
(12) Patent Application Publication
(10) Pub. No.: US 2021/0280347 A1
(43) Pub. Date: Sep. 9, 2021

(54) INSULATING MATERIAL COATED SOFT MAGNETIC POWDER, POWDER MAGNETIC CORE, MAGNETIC ELEMENT, ELECTRONIC DEVICE, AND MOVING BODY

(71) Applicant: SEIKO EPSON CORPORATION, Tokyo (JP)

(72) Inventor: Atsushi NAKAMURA, Hachinohe (JP)

(21) Appl. No.: 17/190,461

(22) Filed: Mar. 3, 2021

(30) Foreign Application Priority Data
Mar. 5, 2020 (JP) 2020-037834

(51) Int. Cl. H01F 1/24; H01F 1/147; H01F 1/33

(52) U.S. Cl. CPC H01F 1/24; H01F 1/33; H01F 1/14766; H01F 1/1475

(57) ABSTRACT

An insulating material coated soft magnetic powder, which is a powder body of an insulating material coated soft magnetic particle 1, includes: a core particle 2 including a base portion 2a that includes a soft magnetic material, and an oxide film 2b that is provided on a surface of the base portion 2a and contains an oxide of an element contained in the soft magnetic material, and an insulating film 3b in which a plurality of insulating nanoparticles 3a are attached to the core particle 2. A particle size of each nanoparticle 3a is 1/50,000 or more and 1/100 or less, relative to a particle size of the core particle 2, and after being subjected to a heat treatment in which the core particle 2 is heated at a sintering temperature or higher, a specific resistance after the heat treatment is 110% or more of a specific resistance before the heat treatment.

The present application is based on, and claims priority from JP Application Serial Number 2020-037834, filed Mar. 5, 2020, the disclosure of which is hereby incorporated by reference herein in its entirety.

### BACKGROUND

### 1. Technical Field

The present disclosure relates to an insulating material coated soft magnetic powder, a powder magnetic core, a magnetic element, an electronic device, and a moving body.

### 2. Related Art

Magnetic elements such as choke coils and inductors provided in an electronic device for mobile use have been known in the related art. The magnetic element includes a powder magnetic core obtained by powder molding a soft magnetic powder and the like. The soft magnetic powder is subjected to an insulating treatment of an insulating film and the like. The insulating treatment has a function of insulating particles of the soft magnetic powder in the powder magnetic core to reduce an eddy current loss, in order to deal with miniaturization and high performance of the electronic device.

The soft magnetic powder is subjected to a heat treatment, that is, a so-called annealing treatment, in order to reduce a residual strain and to lower a coercive force. Therefore, heat resistance against high temperature in the heat treatment is required in the insulating treatment of the insulating film and the like. When the heat resistance is ensured, agglomeration of the soft magnetic powder due to the heat treatment is inhibited, and moldability at the time of powder molding is improved. Accordingly, filling property of the soft magnetic powder in the powder molding is enhanced, and magnetic properties of the powder magnetic core are improved.

For example, JP-A-2019-192868 discloses an insulating material coated soft magnetic powder including core particles that has oxide films on surfaces and insulating particles provided on the surfaces of the core particles.

However, the insulating material coated soft magnetic powder described in JP-A-2019-192868 has a problem that it is necessary to further improve magnetic properties in order to deal with further miniaturization and higher performance of an electronic device. That is, there has been a demand for an insulating material coated soft magnetic powder that is more excellent in moldability and has improved magnetic properties than those in the related art.

### SUMMARY

An insulating material coated soft magnetic powder includes a core particle including a base portion that includes a soft magnetic material, and an oxide film that is provided on a surface of the base portion and contains an oxide of an element contained in the soft magnetic material, and an insulating film in which a plurality of insulating nanoparticles are attached to the core particle. A particle size of each nanoparticle is 1/50,000 or more and 1/100 or less of a particle size of the core particle, and after being subjected to a heat treatment in which the core particle is heated at a sintering temperature or higher, a specific resistance after the heat treatment is 110% or more of a specific resistance before the heat treatment.

A powder magnetic core includes the above insulating material coated soft magnetic powder.

A magnetic element includes the above powder magnetic core.

An electronic device includes the above magnetic element.

A moving body includes the above magnetic element.

### BRIEF DESCRIPTION OF THE DRAWINGS

FIG. 1 is a schematic cross-sectional view showing a particle of an insulating material coated soft magnetic powder according to a first embodiment.

FIG. 2 is a schematic cross-sectional view showing a configuration of a powder coating device.

FIG. 3 is a schematic cross-sectional view showing the configuration of the powder coating device.

FIG. 4 is a schematic cross-sectional view showing a particle of the insulating material coated soft magnetic powder before a heat treatment.

FIG. 5 is an electron micrograph of a cross section near a surface of the particle of the insulating material coated soft magnetic powder before the heat treatment.

FIG. 6 is an electron micrograph of the cross section near the surface of the particle of the insulating material coated soft magnetic powder.

FIG. 7 is a schematic plan view showing a choke coil as a magnetic element according to a second embodiment.

FIG. 8 is a transparent perspective view showing a choke coil as a magnetic element according to a third embodiment.

FIG. 9 is a perspective view showing a configuration of a personal computer for mobile use as an electronic device according to a fourth embodiment.

FIG. 10 is a plan view showing a configuration of a smartphone as an electronic device.

FIG. 11 is a perspective view showing a configuration of a digital still camera as an electronic device.

FIG. 12 is a perspective view showing a vehicle as a moving body according to a fifth embodiment.

### DESCRIPTION OF EXEMPLARY EMBODIMENTS

### 1. First Embodiment

### 1.1 Insulating Material Coated Soft Magnetic Powder

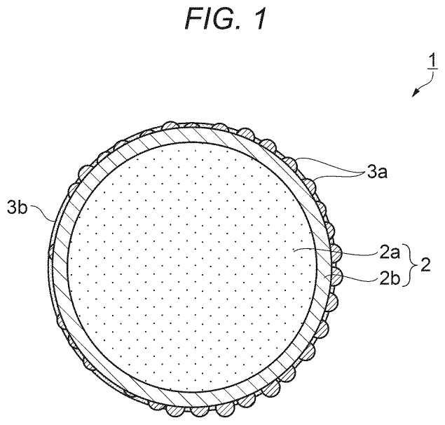

A configuration of an insulating material coated soft magnetic powder according to a first embodiment will be described with reference to FIG. 1. In the following drawings, for convenience of illustration, shapes of particles and scales of members are different from actual ones. In the following description, one particle of the insulating material coated soft magnetic powder is also referred to as an insulating material coated soft magnetic particle.

As shown in FIG. 1, an insulating material coated soft magnetic particle 1 according to the present embodiment includes a core particle 2 including a base portion 2a and an oxide film 2b, and an insulating film 3b. The base portion 2a contains a soft magnetic material described later. The oxide film 2b is provided on a surface of the base portion 2a and contains an oxide of an element contained in the soft magnetic material. The insulating film 3b is provided on a surface of the core particle 2 and has an insulating property.

On the surface of the core particle 2, an insulating film 3b generated from a plurality of insulating nanoparticles 3a and nanoparticles 3a remaining without forming the insulating film 3b coexist. Specifically, in a process of producing the insulating material coated soft magnetic powder, the insulating film 3b attaches the plurality of nanoparticles 3a to the core particle 2 and at least a part or all of the plurality of nanoparticles 3a are melted by being heated at a sintering temperature or higher. Accordingly, the insulating film 3b is formed integrally with the core particle 2. The method for producing the insulating material coated soft magnetic powder, which is a powder body of the insulating material coated soft magnetic particle 1, will be described later.

By the above heat treatment, a part of the plurality of nanoparticles 3a may remain undissolved while maintaining shapes of the nanoparticles 3a, or may exist in a state of being deformed by heat, or may be partially embedded in the oxide film 2b. When the nanoparticles 3a are embedded in the oxide film 2b, a contact area between the core particle 2 and the nanoparticles 3a is expanded. On the surface of the core particle 2, the insulating film 3b may be distributed in an island shape, a region where the insulating film 3b is formed and a region where the nanoparticles 3a remain undissolved may be mixed, or the nanoparticles 3a may be scattered in the insulating film 3b.

Although an effect of the present disclosure is exhibited even if the nanoparticles 3a remaining without forming the insulating film 3b exist on the surface of the core particle 2, the nanoparticles 3a on the surface of the core particle 2 are not essential. Preferably, all of the plurality of nanoparticles 3a attached to the core particle 2 are melted to form the insulating film 3b, and the insulating film 3b and the core particle 2 are integrated. Since all the nanoparticles 3a form the insulating film 3b, the contact area with the core particle 2 is further expanded. Therefore, a coating rate of the insulating film 3b on the surface of the core particle 2 is increased, and an insulating property, a moldability to the powder magnetic core and the like, and magnetic properties of the powder magnetic core are further improved.

Here, in the present specification, integration means one of a complex state in which two objects are diffused to each other and a boundary thereof is ambiguous, and a state in which, even if the boundary between the two objects is clear, no gap or inclusion exists therebetween and the two objects are in close contact with each other.

In the insulating material coated soft magnetic particle 1, since the insulating film 3b exists on the surface of the core particle 2, when a plurality of insulating material coated soft magnetic particles 1 are gathered together to form the insulating material coated soft magnetic powder, insulating property between the particles is ensured. In other words, the insulating film 3b exists on a surface of the insulating material coated soft magnetic particle 1, and thus the core particles 2 are prevented from coming into contact with each other, and an insulating resistance between the core particles 2 is ensured. Accordingly, when the powder magnetic core is produced from the insulating material coated soft magnetic particles 1, an eddy current loss is reduced in a magnetic element provided in the powder magnetic core. Since the nanoparticles 3a also have an insulating property, the above effect is exhibited even if the nanoparticles 3a exist on the surface of the core particle 2.

A shape of the insulating material coated soft magnetic particle 1 is not limited to a substantially spherical shape, and may be, for example, an irregular shape having a plurality of protrusions on the surface. A particle size of the insulating material coated soft magnetic particle 1 is 1 μm or more and 50 μm or less, preferably 2 μm or more and 30 μm or less, and more preferably 3 μm or more and 15 μm or less. Accordingly, in the powder magnetic core produced from the insulating material coated soft magnetic powder, the eddy current loss is reduced and the magnetic properties such as a magnetic permeability and a magnetic flux density are improved.

Here, the actual insulating material coated soft magnetic particle 1 is used as a powder body of a plurality of insulating material coated soft magnetic particles 1 having a particle size distribution, that is, an insulating material coated soft magnetic powder. Therefore, the particle size of the insulating material coated soft magnetic particle 1 can also be referred to as an average particle size of the insulating material coated soft magnetic powders which form a powder body.

The average particle size in the present specification refers to a volume-based particle size distribution (50%). The average particle size is measured by a dynamic light scattering method or a laser diffracted light method described in JIS 28825. Specifically, for example, a particle size distribution meter using the dynamic light scattering method as a measurement principle can be adopted.

1.1.1 Core Particle

Examples of a soft magnetic material of the base portion 2a of the core particle 2 include pure iron, various Fe-based alloys such as a Fe—Si-based alloy which is silicon steel, a Fe—Ni-based alloy which is permalloy, a Fe—Co-based alloy which is permendur, a Fe—Si—Al-based alloy such as sendust, a Fe—Si—Cr-based alloy, and a Fe—Cr—Al-based alloy, various Ni-based alloys, and various Co-based alloys. Among these, it is preferable to use various Fe-based alloys from viewpoints of magnetic properties such as magnetic permeability and magnetic flux density, and cost. In the present embodiment, a Fe—Si—Cr-based alloy is adopted as the soft magnetic material contained in the base portion 2a.

A crystallinity of the soft magnetic material is not particularly limited, and may be crystalline, amorphous, or microcrystalline (nanocrystalline).

The base portion 2a is preferably made of the soft magnetic material as a main raw material. The base portion 2a may contain impurities or additives in addition to the soft magnetic material. Examples of the additives include various metal materials, various non-metal materials, and various metal oxide materials.

The oxide film 2b of the core particle 2 contains an oxide of an element derived from the soft magnetic material contained in the base portion 2a. Specifically, for example, when a Fe—Si—Cr-based alloy is used as the main raw material of the base portion 2a, the oxide film 2b contains one or more of iron oxide, chromium oxide, and silicon oxide. When the Fe—Si—Cr-based alloy contains an element other than main elements Fe, Cr and Si, an oxide of this element may be contained, and oxides of the main elements and the oxide of this element may both be included. In the present embodiment, the oxide film 2b mainly contains silicon oxide, and also contains a small amount of chromium oxide.

Depending on the soft magnetic material used, examples of the oxide contained in the oxide film 2b include, for example, iron oxide, chromium oxide, nickel oxide, cobalt oxide, manganese oxide, silicon oxide, boron oxide, phosphorus oxide, aluminum oxide, magnesium oxide, calcium oxide, zinc oxide and titanium oxide, vanadium oxide, and cerium oxide. The oxide film 2b contains one or more of the above.

Since the oxides have low conductivity, an insulation resistance on the surface of the core particle 2 itself increases. Therefore, when the insulating material coated soft magnetic powder is applied to the powder magnetic core, the eddy current loss is reduced by the oxide film 2b in addition to the insulating properties of the insulating film 3b and the nanoparticles 3a.

When the nanoparticles 3a contain an oxide, the oxide film 2b preferably contains a glass forming component or a glass stabilizing component among the above oxides. Accordingly, adhesion of the nanoparticles 3a to the oxide film 2b is promoted. Specifically, an interaction such as vitrification occurs between the glass forming component or the glass stabilizing component and the nanoparticles 3a, and the oxide film 2b and the nanoparticles 3a strongly adhere to each other. Therefore, the nanoparticles 3a are less likely to fall off from the surface of the core particle 2. By preventing falling off of the nanoparticles 3a, the coating rate of the insulating film 3b and the nanoparticles 3a on the surface of the core particle 2 is improved, and a deterioration of the insulating property is prevented.

The vitrification described above promotes integration of the insulating film 3b and the nanoparticles 3a with the core particle 2. Therefore, for example, even if the insulating material coated soft magnetic particle 1 is placed in an environment where high and low temperatures are repeated, gaps are less likely to occur between the core particle 2 and the insulating film 3b as well as the nanoparticles 3a. Therefore, an intrusion of moisture and the like into the gap is prevented and the insulating property is maintained. That is, a resistance to a temperature change of the insulating material coated soft magnetic particle 1 is improved.

Examples of the glass forming component include silicon oxide, boron oxide, phosphorus oxide and the like. Examples of the glass stabilizing component include aluminum oxide and the like. Among these, the oxide film 2b more preferably contains at least one of silicon oxide, aluminum oxide, and chromium oxide.

The silicon oxide is the glass forming component and the aluminum oxide is the glass stabilizing component. Therefore, in the present embodiment, the interaction such as the vitrification is likely to occur between the silicon oxide or aluminum oxide of the oxide film 2b and the oxide of the insulating film 3b or the nanoparticles 3a. Accordingly, the insulating film 3b or the nanoparticles 3a adhere more strongly to the surface of the core particle 2. Since chromium oxide has high chemical stability, denaturation and deterioration during heat treatment can be prevented. According to the above, the insulating property of the insulating material coated soft magnetic powder can be improved. The type of oxide contained in the oxide film 2b can be specified by, for example, X-ray photoelectron spectroscopy.

Presence or absence of the oxide film 2b in the core particle 2 can be specified from a concentration distribution of oxygen atoms in a direction from the surface of the core particle 2 toward a center thereof, in other words, in a depth direction. Specifically, the concentration distribution of the oxygen atoms in the depth direction of the core particle 2 can be acquired, and the presence or absence of the oxide film 2b can be known from the concentration distribution. In the following description, a concentration of the oxygen atoms is also simply referred to as an oxygen concentration.

The above concentration distribution can be obtained by, for example, a depth direction analysis by Auger electron spectroscopy combined with sputtering. Specifically, the core particle 2 is irradiated with an electron beam, and Auger electrons are emitted from a surface layer of the core particle 2. Based on a kinetic energy of the Auger electrons, atoms existing on the surface layer of the core particle 2 are qualified and quantified. The operation is repeated by causing ions to collide with the surface of the core particle 2 by sputtering, and gradually peeling off an atomic layer on the surface of the core particle 2. Then, by converting time required for the sputtering into a thickness of the atomic layer peeled off by sputtering, a relationship between the depth of from the surface of the core particle 2 and a composition ratio of the atoms can be known.

Here, a position where the depth from the surface of the core particle 2 is 300 nm is considered to be sufficiently deep from the surface. Therefore, an oxygen concentration at the above position can be regarded as an oxygen concentration inside the core particle 2, that is, the base portion 2a. Therefore, the thickness of the oxide film 2b is specified by calculating a relative amount of the base portion 2a with respect to the oxygen concentration from a distribution of the oxygen concentration in the depth direction from the surface of the core particle 2.

Specifically, in a process of producing the core particle 2, oxidation proceeds from the surface of the core particle 2 toward the inside. If the oxygen concentration calculated by the above analysis at a certain depth position of the core particle 2 is in a range within ±50% of the oxygen concentration of the base portion 2a, it is considered that the oxide film 2b does not exist at the position. On the other hand, when the oxygen concentration calculated by the above analysis exceeds+50% of the oxygen concentration of the base portion 2a, it is considered that the oxide film 2b exists. By repeating such evaluation, the thickness of the oxide film 2b can be known.

The thickness of the oxide film 2b in the core particle 2 is 5 nm or more and 200 nm or less, and preferably 10 nm or more and 100 nm or less. Accordingly, the insulating property of the core particle 2 itself is improved. At the same time, since the ratio of the oxide film 2b to the core particle 2 is reduced, a decrease in a density as a magnetic substance in the core particle 2 can be inhibited. An adhesion strength between the oxide film 2b and the insulating film 3b as well as the nanoparticles 3a is further increased, and the insulating film 3b and the nanoparticles 3a are less likely to fall off from the surface of the core particle 2.

A method for producing the core particle 2 is not particularly limited, and examples thereof include known powder production methods such as: an atomizing method such as a water atomizing method, a gas atomizing method, a high-speed rotating water flow atomizing method; a reduction method; a carbonyl method; and a pulverization method. Among these production methods, it is preferable to adopt the water atomizing method or the high-speed rotating water flow atomizing method.

According to the water atomizing method or the high-speed rotating water flow atomizing method, fine powder can be produced efficiently. In the water atomizing method or the high-speed rotating water flow atomizing method, powdering is performed by contact between the molten metal and water, and thus the oxide film 2b having an appropriate thickness is formed on the surface of the core particle 2. Therefore, the core particle 2 provided with the oxide film 2b having an appropriate thickness can be efficiently produced.

The thickness of the oxide film 2b is adjusted by conditions in a process of producing the core particle 2, for example, a cooling rate of the molten metal. Specifically, when the cooling rate is slowed down, the thickness of the oxide film 2b is thicker.

A shape of the core particle 2 is not limited to a substantially spherical shape, and may be, for example, an irregular shape having a plurality of protrusions on the surface. An initial particle size of the core particle 2 before being used for producing the insulating material coated soft magnetic particle 1 is 1 μm or more and 50 μm or less, preferably 2 μm or more and 30 μm or less, and more preferably 3 μm or more and 15 μm or less. Accordingly, in the powder magnetic core produced from the insulating material coated soft magnetic powder, the eddy current loss is reduced and the magnetic properties such as the magnetic permeability and the magnetic flux density are improved.

Here, the actual core particle 2 is used as a powder body of the plurality of core particles 2 having a particle size distribution. Therefore, the particle size of the core particle 2 can also be referred to as an average particle size of the plurality of core particles 2 which form a powder body.

The average particle size of the core particles 2 is adjusted by an amount of molten metal dropped per unit time in the producing process, a pressure and a flow rate of water as a spray medium, and the like. A classification treatment may be performed in order to adjust the average particle size of the core particles 2.

1.1.2 Nanoparticles

The nanoparticles 3a are particles containing an insulating material. Examples of the insulating material contained in the nanoparticles 3a include various ceramic materials such as aluminum oxide, magnesium oxide, titanium oxide, zirconium oxide, silicon oxide, iron oxide, potassium oxide, sodium oxide, calcium oxide, chromium oxide, boron nitride, silicon nitride, and silicon carbide. The nanoparticle 3a contains one or more of the above.

The nanoparticle 3a preferably contains one or more of aluminum oxide, silicon oxide, zirconium oxide, and silicon nitride among the above insulating materials. Since the insulating materials have relatively high hardness and melting point, the hardness and the melting point of the nanoparticles 3a and the insulating film 3b are also high. Therefore, the shape is less likely to change due to a compressive load at the time of powder molding, and molding can be performed at high pressure while inhibiting the deterioration of the insulating property. The heat resistance of the nanoparticles 3a and the insulating film 3b is improved, and an occurrence of agglutination in the heat treatment can be further inhibited. In the embodiment, aluminum oxide is adopted as the nanoparticles 3a.

The insulating material contained in the nanoparticles 3a preferably has a relatively high hardness. Specifically, a Mohs hardness is preferably 6.0 or more, and more preferably 6.5 or more and 9.5 or less. Accordingly, the insulating film 3b and the nanoparticles 3a are less likely to be deformed due to the compressive load at the time of powder molding. Therefore, the insulating property between the particles is less likely to be lowered by the powder molding, and powder molding at high pressure is possible. The powder molding at high pressure contributes to the improvement of the magnetic properties of the powder magnetic core.

Insulating materials having a Mohs hardness in the above range generally have a high melting point, and thus have a relatively high heat resistance. Therefore, even if a high-temperature heat treatment is performed, deformation due to heat is less likely to occur, and characteristics such as filling property for filling into a molding die in the powder molding are less likely to deteriorate.

An initial particle size of each nanoparticle 3 before being used for producing the insulating material coated soft magnetic particle 1 is 1 nm or more and 500 nm or less, preferably 5 nm or more and 300 nm or less, and more preferably 8 nm or more and 100 nm or less. Accordingly, in the process of producing the insulating material coated soft magnetic particle 1, when the nanoparticles 3a are attached to the core particle 2, an appropriate pressure can be applied to the nanoparticles 3a. Accordingly, the plurality of nanoparticles 3a are in good contact with the core particle 2.

Here, actual nanoparticles 3a are used as a powder body of the plurality of nanoparticles 3a having a particle size distribution. Therefore, the particle size of each nanoparticle 3a can also be referred to as an average particle size of the plurality of nanoparticles 3a which form a powder body.

The particle size of each nanoparticle 3a is 1/50,000 or more and 1/100 or less, preferably 1/30,000 or more and 1/300 or less, and more preferably 1/10000 or more and 1/500 or less of the particle size of the core particle 2.

When the particle size of each nanoparticle 3a is within the above range relative to the particle size of the core particle 2, the nanoparticles 3a can adhere to the surface of the core particle 2 with reduced gaps, and a thickness of the insulating film 3b can be made relatively thin. Accordingly, the insulating property and the density as the magnetic substance can be further improved.

1.1.3 Insulating Film

The insulating film 3b covers at least a part of the surface of the core particle 2. The thickness of the insulating film 3b is preferably 3 nm or more and 150 nm or less, and more preferably 10 nm or more and 50 nm or less. Accordingly, the insulating property and the density as the magnetic substance of the insulating material coated soft magnetic particle 1 can be further improved.

For example, after a thin cross-section sample of the insulating material coated soft magnetic particle 1 is prepared by a focused ion beam, the thickness of the insulating film 3b can be measured by a scanning transmission electron microscope. Similarly, an integrated state of the insulating film 3b and the oxide film 2b and a state of adhesion between the nanoparticles 3a and the oxide film 2b can be observed. The thickness of the insulating film 3b is adjusted by conditions such as an amount of nanoparticles 3a attached to the core particle 2 and a temperature and time of the heat treatment in the process of producing the insulating material coated soft magnetic particle 1.

It is preferable that at least a part of the insulating film 3b and the oxide film 2b of the core particle 2 are melted and integrated by the heat treatment in the process of producing the insulating material coated soft magnetic particle 1. Accordingly, the insulating film 3b adheres more firmly to the core particle 2 to prevent itself from falling off, and the insulating property of the insulating material coated soft magnetic particle 1 is further improved.

An integration of the insulating film 3b and the oxide film 2b can be confirmed by preparing a cross-sectional sample in a similar manner as measuring the thickness of the insulating film 3b described above and performing elemental mapping analysis on the sample.

Since the nanoparticles 3a are a forming material, the insulating film 3b contains the same insulating material as the nanoparticles 3a. In the embodiment, since aluminum oxide is adopted as the nanoparticles 3a, the insulating film 3b also contains aluminum oxide.

1.1.4 Other Forming Material

The insulating material coated soft magnetic particle 1 may contain particles having an insulating property other than the nanoparticles 3a, in addition to the above-described forming material. The particles may be disposed on the surface of the core particle 2 in a similar manner as the nanoparticles 3a. Glass particles are adopted as the particles. Examples of components contained in such glass particles include Bi₂O₃, B₂O₃, SiO₂, Al₂O₃, ZnO, SnO, P₂O₅, PbO, Li₂O, Na₂O, K₂O, MgO, CaO, SrO, BaO, Gd₂O₃, Y₂O₃, La₂O₃ and Yb₂O₃, and one or more of the components are adopted.

The insulating material coated soft magnetic particle 1 may contain particles of a non-conductive inorganic material such as a silicon compound in addition to the above glass particles. The content of the particles having insulating property other than the nanoparticles 3a is preferably 50 mass % or less, and more preferably 30 mass % or less with respect to the content of the nanoparticles 3a in the insulating material coated soft magnetic particle 1. Accordingly, the insulating property of the insulating material coated soft magnetic particle 1 can be further improved.

### 1.2 Method for Producing Insulating Material Coated Soft Magnetic Powder

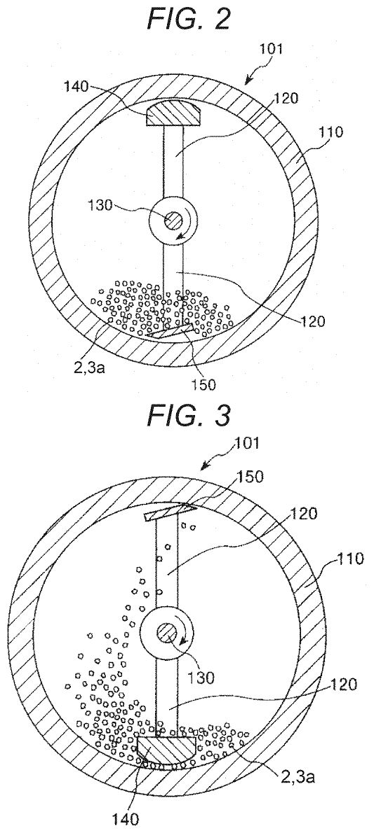

The method for producing the insulating material coated soft magnetic powder according to the present embodiment will be described with reference to FIGS. 2, 3 and 4. Here, in FIGS. 2 and 3, it is assumed that an upper-lower direction in the drawings is along a direction of gravity, and the gravity acts from an upper side to a lower side of the figure. The method for producing the insulating material coated soft magnetic powder described below is an example, and is not limited thereto.

The method for producing the insulating material coated soft magnetic powder of the present embodiment includes a step of preparing the core particles 2 and the nanoparticles 3a, a powder coating step of attaching the nanoparticles 3a to the surface of the core particle 2, and a heat treatment step of performing heat treatment on the core particle 2 to which the nanoparticles 3a are attached.

First, the core particle 2 is prepared. The core particle 2 may be produced by the above-described water atomizing method, high-speed rotating water flow atomizing method, or the like, or a commercially available product may be adopted as the core particle 2. A classification process may be performed to adjust the average particle size of the core particles 2 to a desired value.

Then, the nanoparticles 3a are prepared. A known production method can be adopted for producing the nanoparticles 3a. A commercially available product may be adopted as the nanoparticles 3a. A classification process may be performed to adjust the average particle size of the nanoparticles 3a to a desired value. Then, a processing proceeds to the powder coating step.

In the powder coating step, a mixture of core particle 2 and nanoparticles 3a is first prepared. Specifically, the core particle 2 and the nanoparticles 3a are stirred and mixed using a known stirring machine or a mixing machine. Since the mixture is also stirred when the core particle 2 is coated with the nanoparticles 3a described below, stirring by the above-described stirring machine or mixing machine is not essential.

An amount of the nanoparticles 3a added to the core particle 2 in the above mixture is preferably 0.1 mass % or more and 5.0 mass % or less, and more preferably 0.1 mass % or more and 1.0 mass % or less. Accordingly, the content of the core particle 2 in the powder magnetic core is ensured when the powder magnetic core is produced. Therefore, in the powder magnetic core, the eddy current loss is reduced and the magnetic properties such as the magnetic permeability and the magnetic flux density are improved. Sufficient insulating property is ensured in the insulating material coated soft magnetic powder.

After that, the nanoparticles 3a are mechanically attached to the core particle 2. Specifically, the surface of the core particle 2 is covered with the nanoparticles 3a by mechanically pressing the nanoparticles 3a against the surface of the core particle 2.

A known device can be adopted for attaching, that is, coating, the nanoparticles 3a to the surface of the core particle 2. Examples of a known device include various pulverizers such as a hammer mill, a disc mill, a roller mill, a ball mill, a planetary mill, and a jet mill, various friction mixing device such as Angmill (registered trademark), a high-speed elliptical mixing machine, Mix Muller (registered trademark), a Jacobson mill, Mechanofusion (registered trademark), Hybridization (registered trademark), and various vibration mixers such as a homogenizer.

In the present embodiment, a powder coating device 101 is illustrated as an example of the friction mixing device. As shown in FIGS. 2 and 3, the powder coating device 101 includes a container 110, an arm 120, a rotating shaft 130, and a tip 140. The powder coating device 101 mechanically applies a compressive force and a frictional force to the core particle 2 and the nanoparticles 3a to be processed.

The container 110 has a cylindrical shape and is made of a metal material such as stainless steel. The rod-shaped arm 120 is provided in a radial direction of a cylinder of the container 110. A length of the arm 120 in a longitudinal direction is slightly shorter than an inner diameter of the cylinder of the container 110.

The rotation shaft 130 is inserted in a center of the arm 120 in the longitudinal direction. The arm 120 rotates about the rotating shaft 130. The rotating shaft 130 coincides with a central axis of the cylinder of the container 110.

A tip 140 is provided at one end portion of the arm 120. The tip 140 is provided with a convex curved surface on an inner wall side of the container 110. A length of the arm 120 from the tip 140 to the rotating shaft 130 is set in a manner that the curved surface and an inner wall of the container 110 are separated by a predetermined distance. Accordingly, the curved surface of the tip 140 moves, by a rotational movement of the arm 120, along the inner wall of the container 110 while maintaining a constant distance to the inner wall.

A plate-shaped scraper 150 is provided at the other end portion of the arm 120. Similar to the tip 140, a length of the arm 120 from the scraper 150 to the rotating shaft 130 is set in a manner that a distance from the inner wall of the container 110 is set to a predetermined distance. Accordingly, the scraper 150 has a function of moving along the inner wall of the container 110 and scraping a vicinity of the inner wall by the rotational movement of the arm 120.

The rotating shaft 130 is coupled to a rotation driving device (not shown) provided outside the container 110. Therefore, the rotating shaft 130 rotates the arm 120 by driving the rotation driving device.

A cylindrical inside of the container 110 can be sealed. Therefore, the powder coating device 101 can operate the inside with a reduced pressure or various gas atmospheres. When the powder coating device 101 is in operation, it is preferable that the inside of the container 110 has an atmosphere of an inert gas such as argon gas.

As a procedure for coating the nanoparticles 3a on the surface of the core particle 2, first, a mixture of the core particles 2 and the nanoparticles 3a is put into the inside of the container 110. Next, the inside of the container 110 is sealed and the arm 120 is rotated.

FIG. 2 shows a state in which the tip 140 is positioned on the upper side and the scraper 150 is positioned on the lower side. FIG. 3 shows a state in which the scraper 150 is positioned on the upper side and the tip 140 is positioned on the lower side.

As shown in FIG. 2, the scraper 150 scrapes the core particles 2 and the nanoparticles 3a accumulated on the lower side of the inside of the container 110. Therefore, when the arm 120 rotates, the core particles 2 and the nanoparticles 3a are lifted above by the scraper 150 and then dropped down to be stirred.

As shown in FIG. 3, when the tip 140 reaches the lower side due to the rotational movement of the arm 120, the core particles 2 and the nanoparticles 3a are sandwiched in a gap between the curved surface of the tip 140 and the inner wall of the container 110. The curved surface moves along the inner wall of the container 110 by the rotational movement of the arm 120 while sandwiching the core particles 2 and the nanoparticles 3a in the gap. Accordingly, the core particles 2 and the nanoparticles 3a receive a compressive force and a frictional force.

The rotational movement of the arm 120 is repeated in the above-described state of FIGS. 2 and 3, the compressive force and the frictional force are repeatedly applied, and thereby the surfaces of the core particles 2 are coated with the nanoparticles 3a.

At this time, it is not necessary for the nanoparticles 3a to firmly adhere to the surfaces of the core particles 2, and the nanoparticles 3a may adhere to the surfaces of the core particles 2 to such an extent that the nanoparticles 3a do not fall off from the surfaces of the core particles 2 during the present step and the heat treatment step which is the next step. Therefore, the compressive force and the frictional force received by the core particles 2 and the nanoparticles 3a do not have to be excessively strong, and instead, processing time for powder coating is preferably relatively long.

Accordingly, since the compressive force and the frictional force are relatively reduced, the core particles 2 and the nanoparticles 3a are less likely to be deformed. In particular, generation of a strain in the core particles 2 is inhibited, and a decrease in a coercive force due to the strain can be inhibited. By setting the above-described compressive force and frictional force relatively small and setting the processing time long, an occurrence of gaps and biases on the surfaces of the core particles 2 can be inhibited and the nanoparticles 3a can be allowed to adhere relatively uniformly.

A rotational speed of the rotating shaft 130 for rotating the arm 120, that is, a rotational speed of the arm 120, is appropriately set according to a mass of the mixture put into the inside of the container 110, and the like. The rotational speed is not particularly limited, and is, for example, about 100 to 600 times per minute.

A pressing force when the curved surface of the tip 140 compresses the mixture is appropriately set depending on a size of the tip 140, and the like. The pressing force is not particularly limited, and is, for example, about 30 N to 500 N.

The processing time for powder coating is appropriately set depending on the rotational speed and the pressing force. The processing time is not particularly limited, and may be, for example, about 70 minutes to 4 hours.

The powder coating processing described above is a dry coating method, unlike a wet coating method using a solution or the like. Therefore, the processing can be performed in a dry atmosphere or an inert gas atmosphere, and intervention of water and the like between the core particle 2 and the nanoparticles 3a is prevented, and a long-term durability of the insulating material coated soft magnetic particle 1 is improved.

If necessary, the nanoparticles 3a may be subjected to a surface treatment as a pretreatment for preparing the mixture. Examples of the surface treatment include a hydrophobic treatment. By subjecting the nanoparticles 3a to a hydrophobic treatment, adsorption of moisture on the nanoparticles 3a is prevented. Therefore, an occurrence of deterioration of the core particle 2 due to moisture can be prevented. The hydrophobic treatment can further prevent an occurrence of agglutination in the insulating material coated soft magnetic powder.

Examples of the hydrophobic treatment include trimethylsilylation and arylation such as phenylation. For the trimethylsilylation, for example, a trimethylsilylating agent such as trimethylchlorosilane is adopted. For the arylation, for example, an arylating agent such as an aryl halide is adopted.

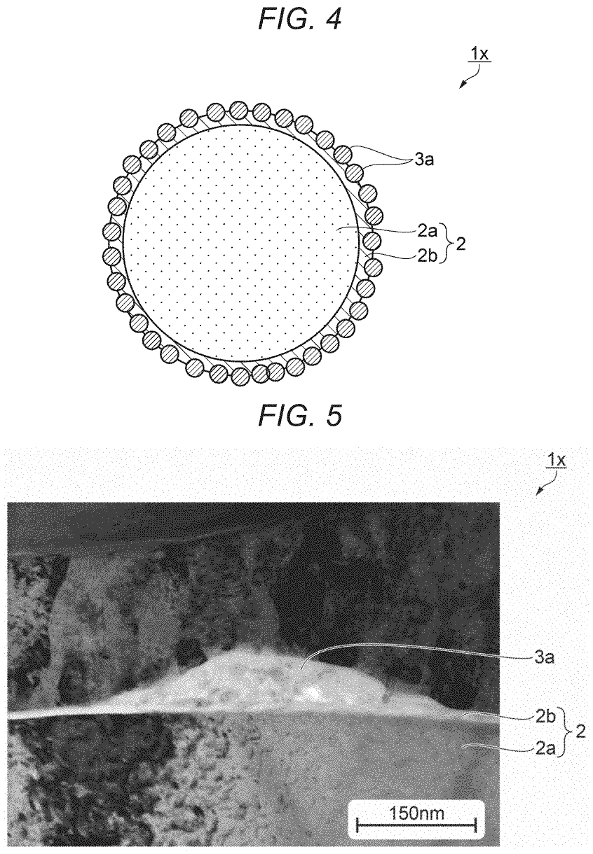

By going through the powder coating step, insulating material coated soft magnetic particles 1x before heat treatment, in which nanoparticles 3a are attached to the surfaces of the oxide films 2b in the core particles 2, are produced. As shown in FIG. 4, in the insulating material coated soft magnetic particle 1x before the heat treatment, nanoparticles 3a that are embedded in the oxide film 2b and nanoparticles 3a that are attached to the surface of the oxide film 2b exist. A state of the nanoparticles 3a on the oxide film 2b is not limited to the above. For example, all nanoparticles 3a may be embedded in the oxide film 2b, or may be attached to the surface of the oxide film 2b without being embedded therein. Then, the processing proceeds to the heat treatment step.

In the heat treatment step, heat treatment is performed by applying heat equal to or higher than the sintering temperature of the nanoparticles 3a to the insulating material coated soft magnetic particles 1x before the heat treatment. By the heat treatment, a strain remaining on the insulating material coated soft magnetic particle 1x before the heat treatment is removed. Accordingly, magnetic properties such as magnetic permeability and coercive force are improved when the powder magnetic core is produced. At least a part of the nanoparticles 3a on the surface of the core particle 2 is melted and the insulating film 3b is formed, and the insulating material coated soft magnetic particle 1 shown in FIG. 1 is formed. Since the heat treatment is performed at a temperature equal to or higher than the sintering temperature of the nanoparticles 3a, a strain is less likely to occur when the insulating material coated soft magnetic particle 1x is subjected to the powder molding, and even if a strain occurs, the strain can be removed by a simple heating treatment.

The sintering temperature of the nanoparticles 3a, that is, a heating temperature of the heat treatment is appropriately set depending on the insulating material contained in the nanoparticles 3a, and may be 600° C. or more and 1200° C. or less, and preferably 900° C. or more and 1000° C. or less. The time for applying the heat treatment, that is, a holding time for the heating temperature is not particularly limited, and may be 30 minutes to 10 hours or less, and preferably 1 hour or more and 6 hours or less. Accordingly, the strain can be removed and the insulating film 3b can be steadily formed in a short time as compared with a case where the temperature and time of the heat treatment are outside the above range.

An atmosphere at a time of the heat treatment is not particularly limited, and examples of the atmosphere include an oxidizing gas atmosphere including oxygen gas, air, or the like, a reducing gas atmosphere including hydrogen gas, ammonia decomposition gas, or the like, an inert gas atmosphere including nitrogen gas, argon gas, or the like, a decompression atmosphere with decompressed optional gas, or the like. Of these atmospheres, the reducing gas atmosphere or the inert gas atmosphere is preferable, and the decompression atmosphere is more preferable. Accordingly, a heat treatment, which is a so-called annealing treatment, can be performed while inhibiting an increase in the thickness of the oxide film 2b of the core particle 2. Therefore, the insulating material coated soft magnetic particle 1 having good magnetic properties and a high coating rate of the core particle 2 by the insulating film 3b can be obtained.

A device used for the heat treatment is not particularly limited as long as the above processing conditions can be set, and a known electric furnace or the like can be adopted.

Here, a ratio of the average particle size of the insulating material coated soft magnetic powder, which is the particle size of the insulating material coated soft magnetic particle 1 after the heat treatment, to an average particle size of the powder body, which is a particle size of the insulating material coated soft magnetic particle 1x before the heat treatment, is 90% or more and 110% or less, preferably 92% or more and 108% or less, and more preferably 95% or more and 105% or less.

This means that in the insulating material coated soft magnetic particle 1x before the heat treatment, since the insulating film 3b and the nanoparticles 3a are interposed between the core particles 2, even the high-temperature heat treatment is performed at a temperature equal to or higher than the sintering temperature of the nanoparticles 3a, the average particle size is less likely to change. In other words, the above indicates that a generation of aggregation due to the high-temperature heat treatment is inhibited. Accordingly, the filling property in the powder molding becomes good and the moldability is improved. Further, since the insulating material coated soft magnetic particle 1 has improved heat resistance, if the insulating material coated soft magnetic particle 1 is applied to a powder magnetic core or a magnetic element, high reliability can be obtained, for example, in an application used in a high temperature environment.

The ratio of the particle sizes is a proof that an apparent reduction of the average particle size due to falling off of the nanoparticles 3a is also inhibited. That is, the falling off of the nanoparticles 3a from the core particle 2 is prevented, and the magnetic properties such as the magnetic permeability and the magnetic flux density are improved when the insulating material coated soft magnetic particle is used as the powder magnetic core.

The ratio of the particle sizes can be adjusted by adjusting the particle sizes of the core particle 2 and the nanoparticles 3a, the amount of the nanoparticles 3a added to the core particle 2 in the above-described mixture, and the like. For example, when the amount of nanoparticles 3a added as the powder body in the mixture is increased, the ratio tends to be a value close to 100%. When the amount of nanoparticles 3a added as the powder body in the mixture is decreased, the ratio tends to be a value away from 100%.

The insulating material coated soft magnetic powder, which is the powder body of the insulating material coated soft magnetic particle 1, may be classified after the heat treatment. Examples of the classification treatment method include dry classification such as sieving classification, inertial classification, and centrifugal classification, and wet classification such as sedimentation classification.

A volume specific resistance of the insulating material coated soft magnetic powder when filled in a container, that is, a specific resistance is preferably 1 MΩ·cm or more, more preferably 5 MΩ·cm or more and 1000 GΩ·cm or less, and further more preferably 10 MΩ·cm or more and 500 GΩ·cm or less.

Such a specific resistance is derived from the oxide film 2b, the insulating film 3b, and the nanoparticles 3a of the insulating material coated soft magnetic particle 1, and does not depend on an additional insulating material. Therefore, if the specific resistance is in the above range, an insulating property between the particles in the insulating material coated soft magnetic powder is ensured, and an amount of the additional insulating material used is reduced. Therefore, when used as the powder magnetic core, a content of the insulating material coated soft magnetic powder in the powder magnetic core can be increased, and both magnetic properties and lower loss can be achieved. Further, a dielectric breakdown voltage of the powder magnetic core can be increased. The specific resistance of the insulating material coated soft magnetic powder and the like can be measured by the following procedure.

1 g of the insulating material coated soft magnetic powder is filled in an alumina cylinder, and brass electrodes are disposed at both ends of the cylinder. Then, while the electrodes at both ends of the cylinder are pressurized with a load of 20 kgf using a digital force gauge, an electrical resistance between the electrodes at both ends of the cylinder is measured by using a digital multimeter. At this time, a distance between the electrodes at both the ends of the cylinder is also measured.

Next, the measured distance between the electrodes during pressurization, the electrical resistance, and a cross-sectional area inside the cylinder are substituted into the following Formula (1) to calculate the specific resistance.

Specific resistance [MΩ·cm]=electrical resistance [MΩ]×cross-sectional area inside cylinder [cm²]/distance between electrodes during pressurization [cm] (1)

The cross-sectional area inside the cylinder is equal to πr² [cm²] when an inner diameter of the cylinder is 2r [cm]. The inner diameter of the cylinder is not particularly limited, and is, for example, 0.8 cm. The distance between the electrodes during the pressurization is not particularly limited, and is, for example, 0.425 cm.

After being subjected to the heat treatment in which the core particles 2 are heated at the sintering temperature or higher, a specific resistance after the heat treatment is 110% or more of a specific resistance before the heat treatment. In other words, a specific resistance of a powder body of the insulating material coated soft magnetic particle 1 is 110% or more of a specific resistance of the powder body of the insulating material coated soft magnetic particle 1x before the heat treatment. Accordingly, since the specific resistance value is increased by the heat treatment, the insulating property is improved.

Through the above process, the insulating material coated soft magnetic powder, which is a powder body of the insulating material coated soft magnetic particle 1, is produced.

According to the present embodiment, the following effects can be obtained.

In the insulating material coated soft magnetic powder, the moldability can be more excellent and the magnetic properties can be improved as compared with that in the related art. Specifically, in the insulating film 3b, at least a part of the nanoparticles 3a is melted and integrated with the oxide film 2b of the core particle 2. Therefore, it is less likely for the nanoparticles 3a in a particle state to fall off from the surface of the core particle 2 as compared with a case where the nanoparticles 3a are attached to the core particle 2. In a region where the insulating film 3b is formed, gaps between the nanoparticles 3a on the surface of the core particle 2 are reduced. Further, since the insulating film 3b is formed by melting the nanoparticles 3a, the insulating film 3b is formed on the surface of the core particle 2 with a thickness thinner than the diameter of each nanoparticle 3a. Therefore, the density as the magnetic substance is improved. As a result, the magnetic properties can be improved when the powder magnetic core is processed.

A smoothness degree of the surface of the core particle 2 is improved in the region where the insulating film 3b is formed, as compared with a case where the nanoparticles 3a in the particle state are attached to the core particle 2. Therefore, the mold can be filled more densely than the molding die at the time of powder molding. Accordingly, the moldability can be improved. From the above, the insulating material coated soft magnetic powder which is more excellent in moldability and has improved magnetic properties as compared with that in the related art can be provided.

When the average particle size of the nanoparticles 3a as the powder body is within a range of 1/50,000 or more and 1/100 or less relative to the average particle size of the core particles 2 as the powder body, the nanoparticles 3a can attach to the surface of the core particle 2 with reduced gaps, and a thickness of the insulating film 3b can be made relatively thin. Accordingly, the insulating property and the density as the magnetic substance can be further improved.

Since the specific resistance of a powder body of the insulating material coated soft magnetic particle 1 is 110% or more of the specific resistance of the powder body of the insulating material coated soft magnetic particle 1x before the heat treatment, the specific resistance value is increased by the heat treatment, and therefore the insulating property is improved.

Since aluminum oxide having a relatively high hardness and melting point is used as the nanoparticles 3a, the hardness and a softening point of the nanoparticles 3a and the insulating film 3b are also high. Therefore, the shape is less likely to change due to a compressive load at the time of powder molding, and molding can be performed at high pressure while inhibiting the deterioration of the insulating property. Further, the heat resistance of the nanoparticles 3a and the insulating film 3b is improved, and an occurrence of agglutination in the heat treatment can be further inhibited.

The oxide film 2b mainly contains silicon oxide, which is a glass forming component. Therefore, the interaction such as the vitrification is likely to occur between the silicon oxide and the aluminum oxide of the insulating film 3b or the nanoparticles 3a. Accordingly, the insulating film 3b or the nanoparticles 3a adhere more strongly to the surface of the core particle 2. The nanoparticles 3a and the insulating film 3b can be prevented from falling off from the core particle 2. The oxide film 2b contains a small amount of chromium oxide. Therefore, denaturation and deterioration during the heat treatment can be inhibited. Accordingly, the insulating property of the insulating material coated soft magnetic powder can be improved.

Since the thickness of the oxide film 2b in the core particle 2 is 5 nm or more and 200 nm or less, the insulating property of the core particle 2 itself is improved. At the same time, since the ratio of the oxide film 2b to the core particle 2 is reduced, the decrease in the density as the magnetic substance in the core particle 2 can be inhibited. An adhesion strength between the oxide film 2b and the insulating film 3b as well as the nanoparticles 3a is further increased, and the insulating film 3b and the nanoparticles 3a are less likely to fall off from the surface of the core particle 2.

Accordingly, since the thickness of the insulating film 3b is 3 nm or more and 150 nm or less, the insulating property of the insulating film 3b and the density as the magnetic substance can be further improved.

Since the average particle size of the core particles 2 as the powder body is 1 μm or more and 50 μm or less, if the powder magnetic core is produced from the insulating material coated soft magnetic powder, the eddy current loss can be reduced and the magnetic properties such as the magnetic permeability and the magnetic flux density can be improved.

### 1.3 Examples and Comparative Examples

Hereinafter, effects of the present disclosure will be described in more detail with reference to Examples and Comparative Examples. The present disclosure is not limited to the following examples.

1.3.1 Cross-Section Observation of Insulating Material Coated Soft Magnetic Particle

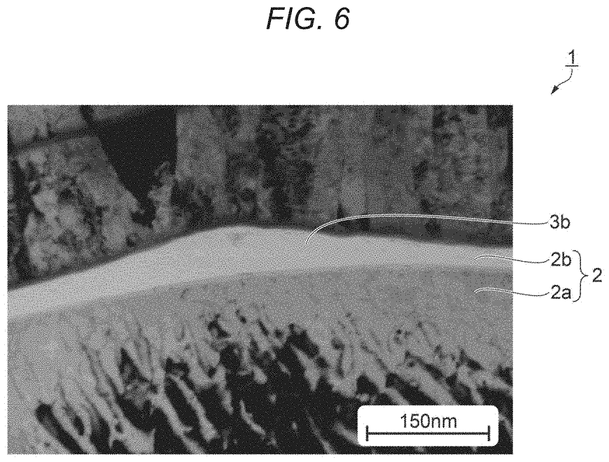

First, as Example A, a cross-sectional observation of the insulating material coated soft magnetic particle 1 in the present embodiment and the insulating material coated soft magnetic particle 1x before treatment was carried out. Surface states before and after the treatment, which are observation results thereof, will be described with reference to FIGS. 5 and 6. FIGS. 5 and 6 are photographs of different particles.

As the core particle 2, a metal powder of a Fe—Si—Cr based alloy produced by a water atomizing method was prepared. As a result of measurement by the above-described method, the average particle size of the metal powder was 10 μm. As a result of an analysis by the method described above, the oxide film 2b of the metal powder mainly contained silicon oxide. Aluminum oxide powder was prepared as the nanoparticles 3a. As a result of measurement by the above-described method, the aluminum oxide powder had the average particle size of 18 nm. In Example A, the surface treatment of the nanoparticles 3a was not performed. Here, in Example A, the average particle size of the powder of the nanoparticles 3a was about 1/556 of the average particle size of the powder of the core particle 2.

Next, an amount of the aluminum oxide powder added to the metal powder in the mixture of the metal powder and the aluminum oxide powder was set to 0.2 mass %, and the mixture was put into the above-described powder coating device 101, and the powder coating step was carried out. Specifically, the rotational speed of the arm 120 in the powder coating device 101 was set to 250 times per minute, and the processing time was set to 150 minutes. Accordingly, the powder body of the insulating material coated soft magnetic particle 1x before the heat treatment is obtained.

A part of the insulating material coated soft magnetic particle 1x before the heat treatment was set aside for an observation to be described later, and a rest part was heat-treated. Specifically, the rest part is heated to a temperature of 1000° C. at a heating rate of 5° C. per minute in an argon gas atmosphere using an electric furnace, held at 1000° C. for 4 hours, and then cooled to about 25° C. Accordingly, the powder body of the insulating material coated soft magnetic particle 1 is obtained.

Next, with respect to the insulating material coated soft magnetic particle 1x before the heat treatment and the insulating material coated soft magnetic particle 1, states of the cross sections near the surface were observed by the above-described method using a focused ion beam and a scanning transmission electron microscope.

As shown in FIG. 5, in the insulating material coated soft magnetic particle 1x before the heat treatment of Example A, nanoparticles 3a are deposited on the oxide film 2b on the surface of the base portion 2a of the core particle 2, and a convex ridge is formed. In the convex ridge region, a plurality of granular parts having different image contrasts can be seen. This indicates that the region consists of a plurality of nanoparticles 3a.

As shown in FIG. 6, in the insulating material coated soft magnetic particle 1 that has undergone the heat treatment of Example A, the granular parts observed in the convex ridge region in FIG. 5 are not observed. This indicates that the plurality of nanoparticles 3a deposited on the surface of the oxide film 2b became the insulating film 3b by the heat treatment. Since the boundary between the oxide film 2b and the insulating film 3b is ambiguous, it is also shown that the oxide film 2b and the insulating film 3b are integrated. Further, the thickness of the oxide film 2b became thicker.

A mechanism of the integration of the oxide film 2b and the insulating film 3b is inferred as follows. In the core particle 2 of the insulating material coated soft magnetic particle 1x before the heat treatment, silicon oxide is distributed on the surface side of the oxide film 2b, chromium oxide is distributed inside the core particle 2, and iron oxide is distributed on a base portion 2a side inside the core particle 2. When heat treatment is performed in this state, silicon contained in the base portion 2a lowers an energy level, and thus iron oxide and some chromium oxide are reduced and precipitated as silicon oxide in the oxide film 2b, and the oxide film 2b becomes thicker. On the other hand, the reduced chromium and iron move to the base portion 2a side. Although aluminum oxide, which is the nanoparticles 3a, usually has a melting point of 2000° C. or more, in addition to a small particle size, the melting point thereof is lowered by contacting with silicon oxide in the oxide film 2b. Accordingly, in the insulating material coated soft magnetic particle 1, aluminum oxide, which is the nanoparticles 3a, is melted to form an insulating film 3b, and the insulating film 3b and the oxide film 2b are integrated.

1.3.2 Evaluation of Insulating Material Coated Soft Magnetic Powder

1.3.2.1 Producing Insulating Material Coated Soft Magnetic Powder

Production conditions and evaluation results of the insulating material coated soft magnetic powder in Examples 1 to 12, the insulating material coated soft magnetic powder in Examples 1 to 4, and the soft magnetic powder in Comparative Example 5 were described with reference to Tables 1 and 2. Hereinafter, Examples 1 to 12 are collectively simply referred to as Examples, and Comparative Examples 1 to 5 are collectively simply referred to as Comparative Examples. Tables 1 and 2 are tables showing the production conditions and the evaluation results of the insulating material coated soft magnetic powder in Examples and Comparative Examples.

TABLE 1

| | | | Ex- | Ex- | Ex- | Ex- | Ex- | Ex- | Ex- | Ex- | Ex- |
|---|---|---|---|---|---|---|---|---|---|---|---|
| | | | ample | ample | ample | ample | ample | ample | ample | ample | ample |
| | | | 1 | 2 | 3 | 4 | 5 | 6 | 7 | 8 | 9 |
| Production | Core | Base portion (soft magnetic | Fe—Si—Cr-based alloy | | | | | | | | |
| condition | particle | material) | | | | | | | | | |
| | | Oxide contained in oxide film | SiO₂ and Cr₂O₃ | | | | | | | | |
| | | Average particle size [μm] | 10 | | | | | | | | |
| | | Oxide film thickness [nm] | 40 | 40 | 40 | 80 | 40 | 40 | 40 | 60 | 40 |
| | Nano- | Kind | Al₂O₃ | Al₂O₃ | Al₂O₃ | Al₂O₃ | Al₂O₃ | Al₂O₃ | Al₂O₃ | Al₂O₃ | SiO₂ |
| | particle | Average particle size [nm] | 18 | 3 | 10 | 10 | 10 | 10 | 10 | 18 | 10 |
| | | Addition amount (mass %) | 0.20 | 0.20 | 0.50 | 0.50 | 0.20 | 0.20 | 0.20 | 0.50 | 0.50 |
| | | Surface treatment performed | None | None | None | None | None | Yes | None | None | None |
| | Powder | Rotational speed of arm [rpm] | 250 | 250 | 250 | 250 | 250 | 250 | 500 | 250 | 250 |
| | coating | Treatment time [min] | 150 | 150 | 150 | 150 | 150 | 150 | 150 | 150 | 150 |
| | Heat | Atmosphere gas | Ar | Ar | Ar | Ar | Ar | H₂ | Ar | H₂ | H₂ |
| | treatment | Heating temperature [° C.] | 1100 | 1100 | 1000 | 1100 | 1100 | 1200 | 1000 | 1000 | 1000 |
| | | Holding time of heating | 8 | 4 | 8 | 1 | 10 | 8 | 8 | 8 | 4 |
| | | temperature [H] | | | | | | | | | |

| | | | | | | | | | | |
|---|---|---|---|---|---|---|---|---|---|---|
| | Ratio of particle sizes of | 1/556 | 1/3333 | 1/1000 | 1/1000 | 1/1000 | 1/1000 | 1/1000 | 1/556 | 1/1000 |
| | nanoparticle/core particle | | | | | | | | | |
| | Ratio of particle sizes before and | 101 | 102 | 102 | 105 | 105 | 105 | 105 | 102 | 102 |
| | after heat treatment [%] | | | | | | | | | |
| Evaluation | Coercive force | A | A | A | B | A | B | B | B | B |
| result | Dielectric breakdown voltage [V] | 700 | 1000 | 850 | 750 | 1000 | 850 | 650 | 750 | 700 |
| | Filling property | B | A | B | B | A | B | B | B | B |
| | Magnetic permeability | A | A | B | B | A | B | B | B | B |
| | Changes in specific resistance | 300 | 250 | 180 | 180 | 300 | 260 | 280 | 150 | 130 |
| | according to heat treatment [%] | | | | | | | | | |
| | Changes in particle specific | 50 | 52 | 56 | 70 | 55 | 65 | 62 | 68 | 66 |
| | surface area | | | | | | | | | |
| | according to heat treatment [%] | | | | | | | | | |

TABLE 2

| | | | | | | Compar- | Compar- | Compar- | Compar- | Compar- |
|---|---|---|---|---|---|---|---|---|---|---|
| | | | | | | ative | ative | ative | ative | ative |
| | | | Example | Example | Example | Example | Example | Example | Example | Example |
| | | | 10 | 11 | 12 | 1 | 2 | 3 | 4 | 5 |
| Production | Core | Base portion (soft magnetic | Fe—Si—Cr-based alloy | | | | | | | |
| condition | particle | material) | | | | | | | | |
| | | Oxide contained in oxide film | SiO₂ and Cr₂O₃ | | | | | | | |
| | | Average particle size [μm] | 10 | | | | | | | |
| | | Oxide film thickness [nm] | 50 | 50 | 40 | 40 | 40 | 50 | 60 | 40 |
| | Nano- | Kind | ZrO₃ | BN | Al₂O₃ | Al₂O₃ | Al₂O₃ | SiO₂ | BN | |
| | particle | Average particle size [nm] | 20 | 10 | 10 | 18 | 12 | 12 | 50 | |
| | | Addition amount (mass %) | 0.40 | 0.40 | 0.30 | 0.85 | 0.59 | 0.59 | 0.54 | |
| | | Surface treatment performed | None | None | None | None | None | None | None | |
| | Powder | Rotational speed of arm | 250 | 250 | 250 | 1200 | 1200 | 1200 | 1200 | |
| | Coating | [rpm] | | | | | | | | |
| | | Treatment time [min] | 150 | 150 | 150 | 60 | 60 | 60 | 60 | |
| | Heat | Atmosphere gas | H₂ | Ar | Ar | H₂ | H₂ | H₂ | H₂ | |
| | treatment | Heating temperature [° C.] | 1000 | 1000 | 1000 | 1000 | 1000 | 1000 | 1000 | |
| | | Holding time of heating | 4 | 4 | 3 | 4 | 4 | 4 | 4 | |
| | | temperature [H] | | | | | | | | |

| | | | | | | | | | |
|---|---|---|---|---|---|---|---|---|---|
| | Ratio of particle sizes of nanoparticle/ | 1/500 | 1/1000 | 1/1000 | 1/556 | 1/833 | 1/833 | 1/200 | |
| | core particle | | | | | | | | |
| | Ratio of particle sizes before and after | 105 | 106 | 100 | 101 | 105 | 106 | 99 | |
| | heat treatment [%] | | | | | | | | |
| Evaluation | Coercive force | B | B | B | A | B | B | B | B |
| Result | Dielectric breakdown voltage [V] | 750 | 700 | 700 | 800 | 300 | 300 | 300 | 0 |
| | Filling property | B | A | B | C | B | B | A | E |
| | Magnetic permeability | B | B | A | C | C | C | C | A |
| | Changes in specific resistance according | 150 | 130 | 180 | 105 | 108 | 107 | 103 | |
| | to heat treatment [%] | | | | | | | | |
| | Changes in particle specific surface area | 63 | 66 | 60 | 85 | 88 | 89 | 87 | |
| | according to heat treatment [%] | | | | | | | | |

The insulating material coated soft magnetic powder in Examples and Comparative Examples were produced. Specifically, a specific method for producing the powder body of the powder of the insulating material coated soft magnetic particle 1 which is the insulating material coated soft magnetic powder in Example 1 will be described. In a similar manner as in Example A, core particles 2 of Fe—Si—Cr-based alloy produced by the water atomizing method were prepared. As a result of measurement by the above-described method, the average particle size of the core particles 2 as a powder body is 10 μm, and the oxide film 2b of the core particle 2 is composed of silicon oxide (SiO₂) and chromium oxide (Cr₂O₃), and the thickness of the oxide film 2b was 40 nm.

The aluminum oxide powder was prepared as the nanoparticles 3a. An average particle size of the nanoparticles 3a was 18 nm as a result of measurement by the above-described method. In Example 1, the surface treatment of the nanoparticles 3a was not performed. Here, in Example 1, the average particle size of the nanoparticles 3a powder was about 1/556 of the average particle size of the powder of the core particle 2. In Table 1, this value is described as 1/556 in a column of a ratio of the particle sizes of nanoparticle/core particle. The following examples and comparative examples are also described in the column of the ratio of the particle sizes of nanoparticle/core particle in Table 1 or Table 2 in a similar manner.

Next, the amount of the powder of nanoparticles 3a added to the mixture of the powder of the core particle 2 and the powder of the nanoparticles 3a was set to 0.20 mass %, and the mixture was put into the above-described powder coating device 101 to carry out the powder coating step. At this time, the processing conditions of the powder coating device 101 were similar as in Example A. Accordingly, the insulating material coated soft magnetic particle 1x before the heat treatment according to Example 1 is obtained. A part of the insulating material coated soft magnetic particle 1x before the heat treatment was set aside for an evaluation to be described later.

Next, the insulating material coated soft magnetic particle 1x before the heat treatment was heat-treated. Specifically, the insulating material coated soft magnetic particle 1x was heated to 1100° C. at a heating rate of 5° C. per minute in an argon gas atmosphere using an electric furnace, held at 1100° C. for 8 hours, and then cooled to about 25° C. Accordingly, the insulating material coated soft magnetic particle 1 is obtained.

A ratio of the particle sizes before and after the heat treatment in Tables 1 and 2 refers to a ratio of the average particle size of the powder body of the insulating material coated soft magnetic particle 1 that has undergone the heat treatment to the average particle size of the insulating material coated soft magnetic particle 1x before the heat treatment. In Example 1, the ratio was 101%. The ratio is shown in Table 1 as the ratio of the particle sizes before and after the heat treatment. The following examples and comparative examples are also described in Table 1 or Table 2 in a similar manner.

The insulating material coated soft magnetic powder according to Example 2 was produced in a similar manner as in Example 1 except that the average particle size of the powder of the nanoparticles 3a was set to 3 nm, and the holding time at 1100° C. in the heat treatment was set to 4 hours. The ratio of the particle sizes of the nanoparticle 3a to the core particle 2 was 1/3333. The ratio of the particle sizes before and after the heat treatment was 102%.

The insulating material coated soft magnetic powder according to Example 3 was produced in a similar manner as in Example 1 except that the average particle size of the powder of the nanoparticles 3a was set to 10 nm, the amount of the powder of the nanoparticles 3a added to the mixture was 0.50 mass %, and the heating temperature in the heat treatment was set to 1000° C. The ratio of the particle sizes of the nanoparticle 3a to the core particle 2 was 1/1000. The ratio of the particle sizes before and after the heat treatment was 102%.

The insulating material coated soft magnetic powder according to Example 4 was produced in a similar manner as in Example 1 except that the thickness of the oxide film 2b in the core particle 2 is 80 nm, the average particle size of the powder of the nanoparticles 3a was set to 10 nm, the amount of the nanoparticles 3a powder added to the mixture was 0.50 mass, and the holding time at 1100° C. in the heat treatment was set to 1 hour. The ratio of the particle sizes of the nanoparticle 3a to the core particle 2 was 1/1000. The ratio of the particle sizes before and after the heat treatment was 105%.

The insulating material coated soft magnetic powder according to Example 5 was produced in a similar manner as in Example 1 except that the average particle size of the powder of the nanoparticles 3a was set to 10 nm, and the holding time at 1100° C. in the heat treatment was set to 10 hours. The ratio of the particle sizes of the nanoparticle 3a to the core particle 2 was 1/1000. The ratio of the particle sizes before and after the heat treatment was 105%.

In the insulating material coated soft magnetic powder according to Example 6, the average particle size of the powder of the nanoparticles 3a was set to 10 nm, and the surface treatment is performed on the core particle 2. The surface treatment was a hydrophobic treatment, and trimethylchlorosilane was used as the trimethylsilylating agent. The insulating material coated soft magnetic powder according to Example 6 was produced in a similar manner as in Example 1 except that a heating atmosphere in the heat treatment was hydrogen gas and the heating temperature was 1200° C. The ratio of the particle sizes of the nanoparticle 3a to the core particle 2 was 1/1000. The ratio of the particle sizes before and after the heat treatment was 105%.

The insulating material coated soft magnetic powder according to Example 7 was produced in a similar manner as in Example 1 except that the average particle size of the powder of the nanoparticles 3a was set to 10 nm, the rotational speed of the arm 120 of the powder coating device 101 in the powder coating step was set to about 500 times per minute, and the heating temperature in the heat treatment was set to 1000° C. The ratio of the particle sizes of the nanoparticle 3a to the core particle 2 was 1/1000. The ratio of the particle sizes before and after the heat treatment was 105%.

The insulating material coated soft magnetic powder according to Example 8 was produced in a similar manner as in Example 1 except that the thickness of the oxide film 2b of the core particle 2 was set to 60 nm, the amount of the nanoparticles 3a powder added to the mixture was 0.50 mass %, the heating atmosphere in the heat treatment was hydrogen gas, and the heating temperature was set to 1000° C. The ratio of the particle sizes of the nanoparticle 3a to the core particle 2 was 1/556. The ratio of the particle sizes before and after the heat treatment was 102%.

As the insulating material coated soft magnetic powder according to Example 9, a silicon oxide powder was prepared as the nanoparticles 3a. As a result of measuring the silicon oxide powder by the above-described method, the average particle size was 10 nm. In Example 9, the surface treatment of the nanoparticles 3a was not performed. The insulating material coated soft magnetic powder according to Example 9 was produced in a similar manner as in Example 1 except that the amount of the powder of the nanoparticles 3a added to the mixture was 0.50 mass %, the heating atmosphere in the heat treatment was hydrogen gas, the heating temperature was set to 1000° C., and the holding time at 1000° C. was set to 4 hours. The ratio of the particle sizes of the nanoparticle 3a to the core particle 2 was 1/1000. The ratio of the particle sizes before and after the heat treatment was 102%.

In the insulating material coated soft magnetic powder according to Example 10, the thickness of the oxide film 2b in the core particle 2 was set to 50 nm. A zirconium oxide powder was prepared as the nanoparticles 3a. As a result of measuring the zirconium oxide powder by the above-described method, the average particle size was 20 nm. In Example 10, the surface treatment of the nanoparticles 3a was not performed. The insulating material coated soft magnetic powder according to Example 10 was produced in a similar manner as in Example 9 except that the amount of the nanoparticles 3a powder added to the mixture was set to 0.40 mass %. The ratio of the particle sizes of the nanoparticle 3a to the core particle 2 was 1/500. The ratio of the particle sizes before and after the heat treatment was 105%.

In the insulating material coated soft magnetic powder according to Example 11, the thickness of the oxide film 2b in the core particle 2 was set to 50 nm. A boron nitride powder was prepared as the nanoparticles 3a. As a result of measuring the boron nitride powder by the above-described method, the average particle size was 10 nm. In Example 11, the surface treatment of the nanoparticles 3a was not performed. Further, the insulating material coated soft magnetic powder according to Example 11 was produced in a similar manner as in Example 1 except that the amount of the nanoparticles 3a powder added to the mixture was 0.40 mass, the heating temperature in the heat treatment was set to 1000° C., and the holding time at 1000° C. was set to 4 hours. The ratio of the particle sizes of the nanoparticle 3a to the core particle 2 was 1/1000. The ratio of the particle sizes before and after the heat treatment was 106%.

The insulating material coated soft magnetic powder according to Example 12 was produced in a similar manner as in Example 3 except that the amount of the powder of the nanoparticles 3a added to the mixture was 0.30 mass %, and the holding time at the heating temperature of 1000° C. in the heat treatment was set to 3 hours. The ratio of the particle sizes of the nanoparticle 3a to the core particle 2 was 1/1000. The ratio of the particle sizes before and after the heat treatment was 100%.

In the insulating material coated soft magnetic powder according to Comparative Example 1, the amount of the nanoparticles 3a powder added to the mixture was set to 0.85 mass %, the rotational speed of the arm 120 of the powder coating device 101 in the powder coating step was set to about 1200 times per minute, and the time of the powder coating processing was set to 1 hour. The insulating material coated soft magnetic powder according to Comparative Example 1 was produced in a similar manner as in Example 1 except that a heating atmosphere in the heat treatment was hydrogen gas, the heating temperature was 1000° C., and the holding time at 1000° C. was set to 4 hours. The ratio of the particle sizes of the nanoparticle 3a to the core particle 2 was 1/556. The ratio of the particle sizes before and after the heat treatment was 101%.

The insulating material coated soft magnetic powder according to Comparative Example 2 was produced in a similar manner as in Comparative Example 1 except that the aluminum oxide powder with an average particle size of 12 nm was used as the powder of the nanoparticles 3a, and the amount of the powder of the nanoparticles 3a added to the mixture was set to 0.59 mass %. The ratio of the particle sizes of the nanoparticle 3a to the core particle 2 was 1/833. The ratio of the particle sizes before and after the heat treatment was 105%.

The insulating material coated soft magnetic powder according to Comparative Example 3 was produced in a similar manner as in Comparative Example 1 except that the thickness of the oxide film 2b in the core particle 2 was set to 50 nm, the silicon oxide powder with an average particle size of 12 nm was used as the powder of the nanoparticles 3a, and the amount of the powder of the nanoparticles 3a added to the mixture was set to 0.59 mass %. The ratio of the particle sizes of the nanoparticle 3a to the core particle 2 was 1/833. The ratio of the particle sizes before and after the heat treatment was 106%.

The insulating material coated soft magnetic powder according to Comparative Example 4 was produced in a similar manner as in Comparative Example 1 except that the thickness of the oxide film 2b in the core particle 2 was set to 60 nm, the boron nitride powder with an average particle size of 50 nm was used as the powder of the nanoparticles 3a, and the amount of the powder of the nanoparticles 3a added to the mixture was set to 0.54 mass %. The ratio of the particle sizes of the nanoparticle 3a to the core particle 2 was 1/200. The ratio of the particle sizes before and after the heat treatment was 99%.

In Comparative Example 5, similar core particles 2 as in Example 1 were used without treatment. Specifically, the core particles 2 were produced by flowing each step in a similar manner as in Example 1 except that the powder coating step with the nanoparticles 3a was omitted.

1.3.2.2 Evaluation of Coercive Force

About the insulating material coated soft magnetic powder according to Examples and the insulating material coated soft magnetic powder and the soft magnetic powder according to Comparative Examples, coercive forces were measured using a VSM system TM-VSM1230-MHHL manufactured by Tamagawa Seisakusho Co., Ltd. as a magnetization measuring device. The coercive forces were evaluated according to the following criteria, and results are shown in Tables 1 and 2. Hereinafter, the insulating material coated soft magnetic powder according to Examples may be simply referred to as the powder of Examples, and the insulating material coated soft magnetic powder and the soft magnetic powder of Comparative Examples may be simply referred to as the powder of Comparative Examples.

A: The coercive force is less than 3.0 [Oe].

B: The coercive force is 3.0 [Oe] or more and less than 3.5 [Oe].

C: The coercive force is 3.5 [Oe] or more and less than 5.0 [Oe].

D: The coercive force is 5.0 [Oe] or more and less than 7.0 [Oe].

E: The coercive force is 7.0 [Oe] or more and less than 10.0 [Oe].

F: The coercive force is 10.0 [Oe] or more.

1.3.2.3. Evaluation of Dielectric Breakdown Voltage

Dielectric breakdown voltages of the powders according to Examples and Comparative Examples were measured by the method described below, and values are shown in Tables 1 and 2.

Specifically, 2 g of each powder in Examples and Comparative Examples was filled in an alumina cylinder having an inner diameter of 8 mm, and brass electrodes were arranged at both ends of the cylinder. Then, in an environment of 25° C., a voltage of 50 V was applied between the electrodes for 2 seconds while applying a pressure of 40 kg/cm² between the electrodes at both ends of the cylinder using the digital force gauge. At this time, the electrical resistance between the electrodes was measured with a digital multimeter to confirm the presence or absence of a dielectric breakdown.

Next, the voltage applied between the electrodes was boosted to 100 V and held for 2 seconds, and the electrical resistance between the electrodes at this time was measured to confirm the presence or absence of the dielectric breakdown.

Further, the voltage applied between the electrodes was boosted to 150 V from 50 V, and the electrical resistance between the electrodes was measured at each time to confirm the presence or absence of the dielectric breakdown. The voltage was boosted by 50 V at each time, and the measurement of the electrical resistance was performed until the dielectric breakdown occurred. A maximum voltage applied between the electrodes was 1000 V, and when dielectric breakdown did not occur at 1000 V, the measurement was ended at 1000 V.

The above series of operations was performed three times while updating the powder each time. Then, the lowest voltage value at which the dielectric breakdown occurred out of the three times was set as the dielectric breakdown voltage.

1.3.2.4 Evaluation of Filling Property

For the powders according to Examples and Comparative Examples, a filling rate was evaluated for the filling property which is an index of the moldability at the time of powder molding, and the results are shown in Tables 1 and 2.

An apparent density of the powder according to Examples and Comparative Examples was measured. Specifically, the measurement was performed based on a metal powder-apparent density measuring method specified in JIS Z 2504: 2012.

A true density of the powder according to Examples and Comparative Examples was measured by a constant volume expansion method. A unit of the apparent density and the true density is g/cm³.

Then, a value obtained by dividing the apparent density by the true density was calculated as the filling rate [%], and each filling rate was evaluated as the filling property according to the following criteria.
A: The filling rate is 40% or more.
B: The filling rate is 35% or more and less than 40%.
C: The filling rate is 30% or more and less than 35%.
D: The filling rate is less than 30%.
E: Sintering occurs in the powder and measurement is not possible.

1.3.2.5 Evaluation of Magnetic Permeability

The ring-shaped magnetic core used for a choke coil, which is a so-called toroidal core, was produced from the powder according to Examples and Comparative Examples, and the magnetic permeability of the toroidal core was measured. Specifically, methyl ethyl ketone solution of the epoxy-based resin as the binder was added to the powder in a manner that a solid content was 2.0 mass %. The epoxy-based resin and the magnetic powder were mixed and dried to form a lump. After the lump was crushed, the lump was press-molded into a ring shape having an outer diameter p of 14 mm, an inner diameter p of 7 mm, and a thickness of 3 mm at a molding pressure of 3000 kgf/cm², and then heated at 150° C. for 30 minutes to obtain the toroidal core. The magnetic permeability at a frequency of 100 kHz was measured for the toroidal coil using an Agilent 4294A Precision Impedance Analyzer. Measured magnetic permeabilities were evaluated according to the following evaluation criteria, and results are shown in Tables 1 and 2.
A: The magnetic permeability is 29 or more.
B: The magnetic permeability is 28 or more and less than 29.
C: The magnetic permeability is 27 or more and less than 28.
D: The magnetic permeability is less than 27.

1.3.2.6 Evaluation of Changes in Specific Resistance in Heat Treatment

A change in specific resistance before and after performing heat treatment on the powder according to Examples and Comparative Examples was measured. The above-described method was adopted as a method for measuring the specific resistance. The measurement was performed before and after the heat treatment of the powders according to Examples and Comparative Examples, and measured values after the heat treatment were divided by measured values before the heat treatment and shown in Tables 1 and 2 as the change in specific resistance [%] due to the heat treatment.

1.3.2.7 Evaluation of Changes in Particle Specific Surface Area in Heat Treatment

For the powders according to Examples and Comparative Examples, changes in the specific surface area of powder particles due to the heat treatment, which is an event that contributes to the moldability, were measured by a gas adsorption method. The measurement was performed before and after the heat treatment of the powders according to Examples and Comparative Examples, and measured values after the heat treatment were divided by measured values before the heat treatment and shown in Tables 1 and 2 as the change in the specific surface area [%]. The smaller the value is, the closer the shape of the powder particles after heat treatment is to a sphere, and the closer the powder particles are to a sphere, the better the filling property at the time of molding, that is, the moldability.

1.3.2.8 Overview of Evaluation Result

As shown in Tables 1 and 2, in the powders according to the Examples, the filling property was evaluated as B or higher, and the change in the specific surface area due to the heat treatment was 70% or less at all levels. Accordingly, it was shown that the powders of Examples were excellent in moldability. It was found that in the powders according to Examples, the coercive force and the magnetic permeability were evaluated as B or higher, and the dielectric breakdown voltage was 650 V or higher at all levels. It was found that in the powders according to Examples, the change in specific resistance due to heat treatment was 110% or more at all levels, and the insulating property was improved. Accordingly, it was shown that the powders according to Examples were shown to have improved magnetic properties.

On the other hand, in the powders according to Comparative Examples, a change in the specific surface area due to the heat treatment was 85% or more at all levels except in Comparative Example 5, and in Comparative Example 1, the filling property was evaluated as C. In the powder according to Comparative Examples, the magnetic permeability was evaluated as C at all levels except in Comparative Example 5, and the dielectric breakdown voltage was 300 V in Comparative Examples 2 to 4. From this, it is shown that a high magnetic permeability and a high withstand voltage are not compatible in Comparative examples. Further, in Comparative Example 5, it was found that the filling property was evaluated as E, and the insulating property could not be ensured. In Comparative Example 5, since the agglutination occurred due to sintering during the heat treatment, a change in the specific surface area due to the heat treatment could not be confirmed. From the above, it was found that the powders according to Comparative Examples were inferior to the powders according to Examples in moldability and magnetic properties.

### 2. Second Embodiment

### 2.1 Powder Magnetic Core and Choke Coil

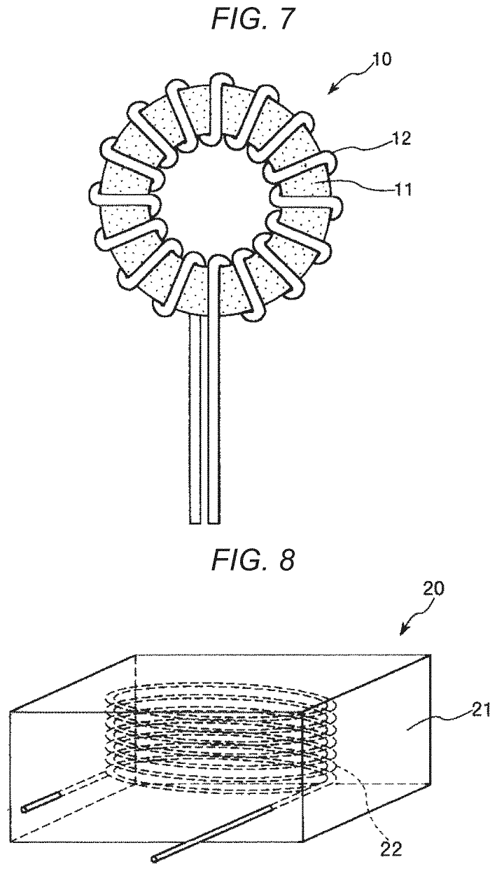

The powder magnetic core according to the second embodiment and the magnetic element provided with the powder magnetic core will be described with reference to FIG. 7. In the present embodiment, the choke coil is exemplified as the magnetic element. The magnetic element according to the present embodiment is not limited to the choke coil, and can be applied on various types of magnetic elements having a magnetic core such as an inductor, a noise filter, a reactor, a transformer, a motor, an actuator, an antenna, an electromagnetic wave absorber, a solenoid valve, and a generator. The powder magnetic core of the present embodiment can be applied to the magnetic core provided in each of the above various magnetic elements.

As shown in FIG. 7, a choke coil 10 includes a ring-shaped (toroidal-shaped) powder magnetic core 11 and a conducting wire 12 wound around the powder magnetic core 11. Such a choke coil 10 is generally called a toroidal coil. A shape of the powder magnetic core 11 is not limited to the ring shape.

The powder magnetic core 11 contains an insulating material coated soft magnetic powder which is a powder body of the insulating material coated soft magnetic particle 1 of the above embodiment, and the insulating material coated soft magnetic powder is obtained by powder molding. Specifically, the powder magnetic core 11 is produced by mixing, as forming materials, the powder body of the insulating material coated soft magnetic particle 1, a binding member which is a binder, and an organic solvent, and pressure molding the obtained mixture by a molding die. Various additives may be appropriately contained in the mixture.

The powder magnetic core 11 may contain a soft magnetic powder other than the insulating material coated soft magnetic powder, if necessary. In this case, a mixing ratio of the insulating material coated soft magnetic powder to the other soft magnetic powder is not particularly limited, and can be set to any value. In a case where the powder magnetic core 11 contains another soft magnetic powder, the type of the other soft magnetic powder is not limited to one.

Examples of forming materials of the binding material used in the powder magnetic core 11 include organic materials such as silicone-based resins, epoxy-based resins, phenol-based resins, polyamide-based resins, polyimide-based resins, and polyphenylene sulfide-based resins, and inorganic materials such as phosphates such as magnesium phosphate, calcium phosphate, zinc phosphate, manganese phosphate, and cadmium phosphate, and silicates such as sodium silicate (water glass). Among these, it is preferable to use a thermosetting polyimide resin and an epoxy resin. Accordingly, since the thermosetting polyimide resin and the epoxy resin have higher curability and heat resistance by heating than other binders, the powder magnetic core 11 can be easily produced and the heat resistance of the powder magnetic core 11 can be improved.

In the powder magnetic core 11, the binding material is not an essential forming material, and may be used if necessary. Even when a binding member is not used for the powder magnetic core 11, the insulating material coated soft magnetic powder according to the above embodiment secures insulation between particles, and therefore loss due to conduction between particles can be prevented.

A proportion of the binding material contained in the powder magnetic core 11 relative to the content of the insulating material coated soft magnetic powder is preferably 0.5 mass % or more and 5.0 mass % or less, and more preferably 1.0 mass % or more and 3.0 mass % or less, although the proportion varies slightly depending on a desired saturation magnetic flux density, mechanical properties, an allowable eddy current loss, and the like. Accordingly, in the powder magnetic core 11, the particles of the insulating material coated soft magnetic powder can be sufficiently bonded to each other, and the magnetic properties, such as the saturation magnetic flux density and the magnetic permeability, can be improved.

The organic solvent is not particularly limited as long as the binding material can be dissolved, and examples thereof include various solvents such as toluene, isopropyl alcohol, acetone, methyl ethyl ketone, chloroform, and ethyl acetate. The organic solvent is a component that volatilizes in the process of producing the powder magnetic core 11.

A highly conductive forming material is adopted for the conducting wire 12 wound around the powder magnetic core 11. Examples of such a forming material include metals containing Cu, Al, Ag, Au, Ni and the like.

The conducting wire 12 preferably includes a surface layer having an insulating property on a surface. The surface layer prevents an occurrence of a short circuit between the powder magnetic core 11 and the conducting wire 12. The surface layer is made of, for example, various resin materials.

### 2.2 Method for Producing Choke Coil

The method for producing the choke coil 10 according to the present embodiment will be described.

First, the insulating material coated soft magnetic powder, the binding material, the organic solvent, and the various additives are mixed to prepare the mixture. The mixture is dried to form a lump, and then the lump is pulverized to obtain a granulated powder.

Next, the granulated powder is formed into a desired powder magnetic core shape to obtain a molded body. At the time, the molding method of the granulated powder is not particularly limited, and examples thereof include press molding, extrusion molding, and injection molding. At this time, a shape and dimensions of the molded body are assumed to allow for shrinkage when the molded body is heated. When press molding is adopted, a molding pressure is about 1 t/cm² (98 MPa) or more and 10 t/cm² (981 MPa) or less.

Next, the molded body is heated and the binding material is cured. The heating temperature of the molded body is appropriately set according to a type and a content of the binding material. For example, when an organic material is used as the binding material, the heating temperature is preferably about 100° C. or more and 500° C. or less, and more preferably about 120° C. or more and 250° C. or less. Heating time of the molded body is appropriately set according to the heating temperature, and is, for example, about 30 minutes or more and 5 hours or less. The heated molded body is cooled, and the powder magnetic core 11 is obtained. Then, the conducting wire 12 is wound around an outer peripheral surface of the powder magnetic core 11 to form the choke coil 10.

Here, in the present embodiment, although the powder magnetic core 11 is exemplified as an application of the insulating material coated soft magnetic powder, the application is not limited to thereto. The insulating material coated soft magnetic powder may be applied to a magnetic device containing a powder body such as a magnetic blocking sheet and a magnetic head.

According to the present embodiment, the following effects can be obtained.

The powder magnetic core 11 having improved insulating properties and magnetic properties, and the choke coil 10 having improved magnetic properties can be provided.

Specifically, the powder magnetic core 11 contains the powder body of the insulating material coated soft magnetic particle 1 according to the above embodiment. Therefore, the powder magnetic core 11 has improved insulating property and heat resistance between particles, and eddy current loss is reduced even in a high temperature environment. Since the insulating material coated soft magnetic powder is heat-treated at a high temperature, the coercive force is lowered and a hysteresis loss is reduced. Accordingly, the powder magnetic core 11 is reduced in loss and the magnetic properties are improved. Further, the choke coil 10 provided with the powder magnetic core 11 also has higher performance and lower loss. Therefore, when the powder magnetic core 11 and the choke coil 10 are mounted on an electronic device or the like, the power consumption of the electronic device or the like can be reduced, a performance can be improved, and reliability in a high temperature environment can be improved.

### 3. Third Embodiment

The powder magnetic core according to the third embodiment and the magnetic element provided with the powder magnetic core will be described with reference to FIG. 8. In the present embodiment, the choke coil is exemplified as the magnetic element. The choke coil according to the present embodiment has a different shape and arrangement of the powder magnetic core and the conducting wire from the choke coil 10 according to the second embodiment. Therefore, descriptions will be omitted for same configurations as in the second embodiment.

As shown in FIG. 8, in the choke coil 20 according to the present embodiment, a conducting wire 22 that is formed into a shape of a coil is embedded inside a powder magnetic core 21. That is, the choke coil 20 includes the powder magnetic core 21, and the conducting wire 22 is embedded in the powder magnetic core 21. The powder magnetic core 21 contains the insulating material coated soft magnetic powder which is the powder body of the insulating material coated soft magnetic particle 1 of the first embodiment, and the insulating material coated soft magnetic powder was obtained by powder molding.

In order to manufacture the choke coil 20, first, the conducting wire 22 was disposed in a cavity of the molding die, and at the same time, the cavity was filled with the granulated powder containing the insulating material coated soft magnetic powder. That is, the conducting wire 22 is disposed in the cavity in a manner of being included in the granulated powder. The granulated powder contains similar forming material as the granulated powder according to the second embodiment, and is produced in a similar manner.

Next, the granulated powder was pressure-molded together with the conducting wire 22 with a molding die to obtain the molded body. Then, in a similar manner as in the second embodiment, the molded body was heated to obtain a powder magnetic core 21 in which the conducting wire 22 was embedded, that is, the choke coil 20.

According to the present embodiment, the following effects in addition to the effects according to the second embodiment can be obtained.

The choke coil 20 is relatively easy to miniaturize. Therefore, the choke coil 20 having a low loss and a low heat generation that can deal with a large current while being compact can be provided. Since the conducting wire 22 is embedded in the powder magnetic core 21, a gap is less likely to occur between the conducting wire 22 and the powder magnetic core 21. Therefore, a vibration due to a magnetostriction of the powder magnetic core 21 can be prevented, and a generation of noise due to the vibration can be prevented.

### 4. Fourth Embodiment

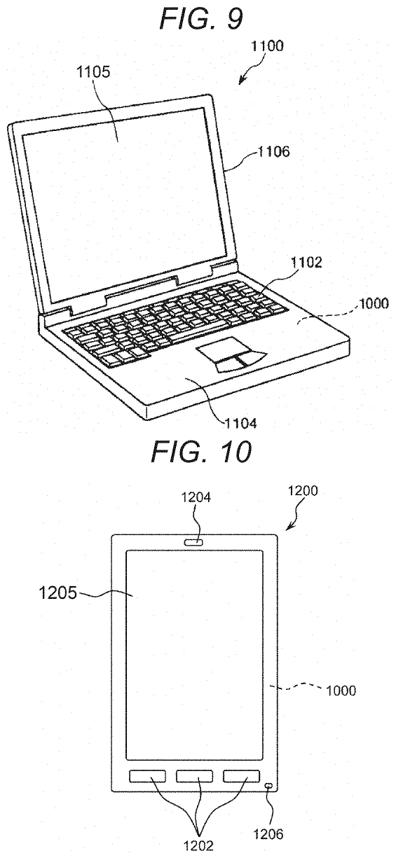

Next, an electronic device according to a fourth embodiment will be described with reference to FIGS. 9, 10 and 11. The electronic device according to the present embodiment includes the magnetic element according to the above embodiment. In the following description, mobile personal computers, smartphones, and digital still cameras will be exemplified as the electronic device according to the present embodiment. The electronic device provided with the magnetic element according to the above embodiment is not limited to the above.

As shown in FIG. 9, a mobile personal computer 1100 as the electronic device according to the present embodiment includes a main body portion 1104 including a keyboard 1102 and a display unit 1106 including a display portion 1105. For the display portion 1105, for example, a liquid crystal display device is adopted. The display unit 1106 is rotatably supported to the main body portion 1104 via a hinge structure portion (not shown). The personal computer 1100 incorporates, for example, a choke coil or an inductor for a switching power supply, and a magnetic element 1000 such as a motor.

As shown in FIG. 10, a smartphone 1200 as an electronic device of the present embodiment includes a plurality of operation buttons 1202, an earpiece 1204, and a mouthpiece 1206. A display portion 1205 is disposed between the operation button 1202 and the earpiece 1204. The smartphone 1200 incorporates, for example, a magnetic element 1000 such as an inductor, a noise filter, and a motor.

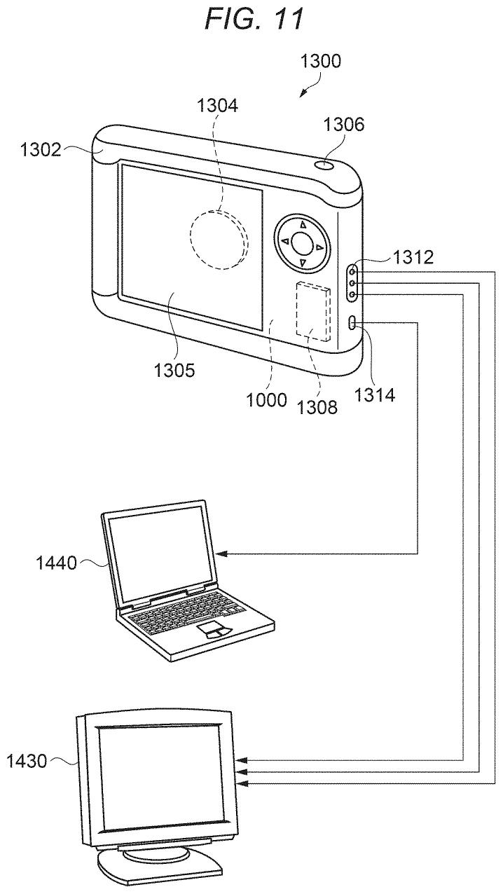

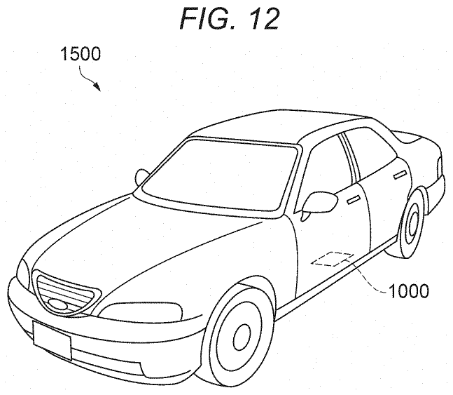

As shown in FIG. 11, a digital still camera 1300 as an electronic device of the present embodiment includes a case 1302, a light receiving unit 1304, a shutter button 1306, and a memory 1308. The digital still camera 1300 generates an imaging signal by photoelectrically converting an optical image of a subject with an imaging element such as a charge coupled device (CCD). FIG. 11 also briefly shows a connection between the digital still camera 1300 and an external device.

A display portion 1305 is disposed on the back surface of the case 1302. The display portion 1305 displays a captured image based on an imaging signal obtained by the CCD (not shown). The display portion 1305 functions as a viewfinder displaying a subject as an electronic image. For the display portion 1305, for example, a liquid crystal display device is adopted. A light receiving unit 1304 including an optical lens, a CCD, and the like is disposed on aback surface side in FIG. 11 which is a front surface of the case 1302.

When using the digital still camera 1300, an imager confirms an electronic image of the subject displayed on the display portion 1305 and presses the shutter button 1306, and thereby the imaging signal of the CCD, which is the electronic image, is transferred to the memory 1308 and stored.

The digital still camera 1300 has an output terminal 1312 for a video signal and an input/output terminal 1314 for data communication on a side surface of the case 1302. For example, a television monitor 1430 is connected to the output terminal 1312, and a personal computer 1440 is connected to the input/output terminal 1314, respectively, if necessary. Accordingly, the imaging signal stored in the memory 1308 is output to the television monitor 1430 and the personal computer 1440. The digital still camera 1300 incorporates, for example, a magnetic element 1000 such as an inductor and a noise filter.

The magnetic element of the above embodiment is applied to the magnetic element 1000 provided in the above-described three types of electronic devices. The electronic device of the present embodiment is not limited to the mobile personal computer 1100, the smartphone 1200, and the digital still camera 1300. Examples of the electronic device provided with the magnetic element of the above embodiment include a mobile phone, a tablet terminal, a wearable terminal, a timepiece, an inkjet ejection device such as an inkjet printer, a laptop personal computer, a television, a video camera, a video tape recorder, navigation devices such as car navigation systems, pagers, electronic organizers including communication functions, electronic dictionaries, calculators, electronic game devices, word processors, workstations, videophones, security television monitors, electronic binoculars, point of sale (POS) system terminals, medical devices such as electronic thermometers, blood pressure monitors, blood glucose meters, electrocardiogram measuring devices, ultrasonic diagnostic devices, and electronic endoscopes, a fish finder, various measuring devices, instruments for vehicles, aircraft, and ships, mobile control devices such as an automobile drive control device, and a flight simulator.

According to this embodiment, it is possible to provide a small-sized and high-performance electronic device.

### 5. Fifth Embodiment

An automobile as a moving body according to a fifth embodiment will be described with reference to FIG. 12.

As shown in FIG. 12, an automobile 1500 of the present embodiment includes the magnetic element 1000. The magnetic element of the above embodiment is applied to the magnetic element 1000.

Specifically, the magnetic element 1000 is built into various automobile parts such as electronic control units such as car navigation systems, anti-lock braking systems, engine control units, power control units for hybrid and electric vehicles, vehicle body attitude control systems, autonomous driving systems, and air conditioning control units, drive motors, generators, and batteries.

Here, the moving body to which the magnetic element 1000 is applied is not limited to an automobile, and may be, for example, a motorcycle, a bicycle, an aircraft, a helicopter, a ship, a submarine, a railroad vehicle, a rocket, a spaceship, and the like.

According to the embodiment, a moving body having excellent reliability even at a high temperature and having high performance can be provided.

The embodiments described above describe an example of the present disclosure. The present disclosure is not limited to the above-described embodiments, and various modifications of the present disclosure implemented without changing the spirit of the present disclosure are also included in the present invention.

What is claimed is:

1. An insulating material coated soft magnetic powder comprising:
a core particle including a base portion that includes a soft magnetic material, and an oxide film that is provided on a surface of the base portion and contains an oxide of an element contained in the soft magnetic material; and
an insulating film in which a plurality of insulating nanoparticles are attached to the core particle, wherein a particle size of each nanoparticle is 1/50,000 or more and 1/100 or less relative to a particle size of the core particle, and
after being subjected to a heat treatment in which the core particle is heated at a sintering temperature or higher, a specific resistance after the heat treatment is 110% or more of a specific resistance before the heat treatment.

2. The insulating material coated soft magnetic powder according to claim 1, wherein
the insulating film is in a state in which a part or all of the plurality of nanoparticles attached to the core particle are melted and integrated with the core particle.

3. The insulating material coated soft magnetic powder according to claim 1, wherein
the nanoparticles preferably contain at least one of aluminum oxide, silicon oxide, zirconium oxide, and silicon nitride.

4. The insulating material coated soft magnetic powder according to claim 3, wherein
the oxide film preferably contains at least one of silicon oxide, aluminum oxide, and chromium oxide.

5. The insulating material coated soft magnetic powder according to claim 1, wherein
a thickness of the oxide film is 5 nm or more and 200 nm or less.

6. The insulating material coated soft magnetic powder according to claim 1, wherein
a thickness of the insulating film is 3 nm or more and 150 nm or less.

7. The insulating material coated soft magnetic powder according to claim 1, wherein
at least a part of the insulating film and the oxide film are melted and integrated.

8. The insulating material coated soft magnetic powder according to claim 1, wherein
a particle size of the core particle is 1 μm or more and 50 μm or less.

9. A powder magnetic core comprising:
the insulating material coated soft magnetic powder according to claim 1.

10. A magnetic element comprising:
the powder magnetic core according to claim 9.

11. An electronic device comprising:
the magnetic element according to claim 10.

12. A moving body comprising:
the magnetic element according to claim 10.
